(19) United States
(12) Patent Application Publication
(10) Pub. No.: US 2009/0285518 A1
(43) Pub. Date: Nov. 19, 2009

(54) AXIAL ROLLING BEARING

(75) Inventors: Wolfgang Fugel, Nuernberg (DE); Stefanie Gumbmann, Weisendorf (DE); Andreas Kirschner, Aurachtal (DE); Sebastian Kroener, Shanghai (CN); Alexander Reimchen, Herzogenaurach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/373,125

(22) PCT Filed: Jun. 1, 2007
(86) PCT No.: PCT/EP07/55378

§ 371 Date: Jan. 9, 2009

(30) Foreign Application Priority Data
Jul. 11, 2006 (DE) 10 2006 031 943.5

(51) Int. Cl. F16C 33/46

(52) U.S. Cl. 384/623

(57) ABSTRACT

The invention relates to an axial rolling bearing having a cage which contains rolling bodies that are arranged between two running disks. The running disks each have a radial section that forms a raceway and an axially aligned collar which adjoins the raceway. The collars are aligned opposite to one another and overlap in the axial direction. The radially outer disk has a larger diameter than the radially inner running disk. According to the invention, the radial and the axial extent of the two collars of the running disks and the cage are coordinated with one another in such a way that, between them, a labyrinth seal, composed of a plurality of gaps, is formed, and the cage is guided on the collar of the radially inner running disk.

### FIELD OF APPLICATION OF THE INVENTION

The invention relates to an axial rolling bearing, composed of a cage which contains rolling bodies and is arranged between two running disks, wherein the running disks each have a radial section which forms a raceway, and at their radial outer ends they each have an adjoining axially aligned collar, which collars are arranged opposite one another in the axial direction and overlap, wherein the radially outer running disk has a larger diameter than the radially inner running disk.

### BACKGROUND OF THE INVENTION

Such an axial rolling bearing is previously known from DE 195 35 085 A1. The axial rolling bearing which is illustrated in FIGS. 1 and 2 of this prior printed publication is composed of a cage which contains rolling bodies and which is arranged between two plane-parallel running disks which are thin-walled, in particular formed from sheet metal, wherein these three components are combined to form one unit by engaging one behind the other in a positively locking fashion One of the running disks has an axially directed collar on its outer radial end, and the other running disk also has an axially directed collar on its outer end, wherein the collars are matched to one another in the radial direction in such a way that a circumferential annular gap is produced in which a rim of the cage is guided. Assuming that the right-hand running disk is securely fixed in a housing, when a shaft (not illustrated) is lifted from the associated other running disk, the shaft will firstly fall onto the axially directed rim of the cage, which is then in turn supported on the axially directed collar of the other running disk.

This configuration of the axial rolling bearing ensures that the forces which occur in the bearing as a result of the shaft being fitted onto the running disk again are transmitted only between the collars of said running disks and the rim of the cage.

As is apparent from viewing FIGS. 1 and 2, lubricant can flow through such an axial bearing without impedance in the radial direction from the inside to the outside owing to the large distance between the two collars. Such bearings are preferably used in particular if lubricant which is required to lubricate the axial bearing and to lubricate other components of a transmission is to flow through with as little resistance as possible. However, such structures which are open in terms of flow do not only have advantages. As a result of the structures which are open in terms of flow it is in fact also possible for there to be comparatively high consumption of lubricants which are circulated by hydraulic pumps in the transmission or pumped into the transmission. The lower the flow resistance of the axial rolling bearings, the higher the quantity required of circulated lubricant which in turn requires a pump with a relatively high power. A person skilled in the art is also aware of the fact that conventional axial rolling bearings themselves act as a pump starting from a specific rotational speed, as a result of which the quantity of lubricant to be circulated is increased once more.

A further axial rolling bearing of the generic type is known from FIG. 3 in FR 1.327.643. As the figure shows, the axial rolling bearing is composed of two running disks which are arranged parallel to one another and which each have at their outer radial end an axially aligned collar which collars are arranged opposite one another, wherein the collar of the outer running disk encloses the collar of the inner running disk at a distance. Rolling bodies are arranged in the intermediate space between the running disks and are guided in a cage and, therefore, spaced apart from one another evenly in the circumferential direction. This cage has in each case at its radially outer end two sealing lips which are directed in the axial direction and which bear against one running disk each with pre-stress. However, such an axial rolling bearing cannot be used in transmissions of internal combustion engines since because there is the seal it is not possible for lubricant to flow through it from the inside to the outside in the radial direction. Furthermore, the two collars of the running disks rub one against the other because of the lack of lubricant, with the result that the bearing would heat up unnecessarily.

A further axial rolling bearing of the generic type is known from DE 29 22 476 A1. As is apparent from the associated description and FIG. 2, this bearing is in turn composed of two running disks which are arranged parallel to one another and whose radial sections form the rolling face for cylinder rollers which are arranged in a cage. At the radially outer end, the two running disks likewise each have an axially directed collar, which are arranged opposite one another. The two collars are spaced apart relatively far from one another in the radial direction, with the result that a circumferential annular gap is formed in which a sealing element is arranged. The sealing element is attached by its base surface to the collar of the inner running disk and bears under pre-stress with a sealing lip against the collar of the outer running disk. This means that this collar cannot be used in transmissions of internal combustion engines either since it is completely sealed, i.e. it is not possible for a flow of lubricant to pass through it from the inside to the outside in the radial direction.

### OBJECT OF THE INVENTION

Taking the disadvantages of the known prior art as a basis, the invention is therefore based on the object of making available an axial rolling bearing which does not have the outlined disadvantages. In particular, the bearing is intended to have a predeterminable flow of lubricant which corresponds only to that quantity of lubricant which the bearing itself requires for fault-free operation.

### SUMMARY OF THE INVENTION

According to the invention, this object is achieved in accordance with the characterizing part of claim 1 in conjunction with its preamble by virtue of the fact that the radial extent and the axial extent of the two running disks and their collars and the cage are coordinated with one another in such a way that a labyrinth seal which is composed of a plurality of gaps is formed between them, wherein the cage is guided on the collar of the radially inner running disk.

This design advantageously ensures that as many axial and radial overlaps as possible are formed to act as a throttle and, to a large extent, prevent unimpeded flow through the rolling bearing. The flow of lubricant is frequently deflected from the inside to the outside as it flows through in the radial direction, with the result that the flow of lubricant can, on the one hand pass the axial rolling bearing only over a comparatively long path, but on the other hand, the basic supply of the axial rolling bearing with lubricant is maintained.

Further advantageous variants of the embodiment of the invention are described in subclaims 2 to 8.

For example, claim 2 discloses that the cage is guided in the axial direction on the radial section of the rotating running disk. As a result of the bearing of the cage against the rotating running disk, an additional sealing gap is formed between the cage and the radial section of this running disk, which sealing gap hinders the passage of lubricant once more.

According to a further feature of the invention according to claim 3, there is provision that the cage is guided in the axial direction on the radial section of the fixed running disk. Compared to guiding the cage on the radial section of the rotating running disk, in this case it is made somewhat easier for lubricant to flow through the bearing, i.e. the throttling effect is somewhat reduced.

According to a further additional feature of the invention, the cage is to have a first axially extending rim on its outer radial end. As a result of this technical measure, a relatively long gap is in turn formed between the collar of the inner running disk and the rim of the cage, which gap hinders the passage of lubricant at the radially outer end.

Claim 5 discloses that the radially outer running disk has, on its radially inner end, an axially directed collar which forms a labyrinth seal with a second axially extending rim of the cage. This sealing gap hinders the influx of lubricant into the rolling bearing once more.

According to claim 6, the radially inner running disk is to have a flange which is aligned opposite the collar which is arranged on the outer radial end. This flange serves in particular as a baffle plate for the flow of lubricant, wherein this flange is particularly advantageous if further loads, for example other bearings, which have to be supplied with lubricant, are arranged downstream of the axial bearing according to the invention.

According to a further additional feature according to claim 7, the collar of the radially outer running disk is to have at least one securing nose which points inward in the radial direction and which covers the collar of the radially inner running disk, with the result that a captive unit is formed. This configuration has the advantage that the axial rolling bearing according to the invention cannot break up into its individual components during transportation, and can easily be mounted by the end user.

Finally, in accordance with a last feature of the invention according to claim 8, there is provision that the rolling bearings are embodied as rollers or as needles. Due to their contact face, such axial rolling bearings have a particularly high load-bearing capacity.

The invention will be explained in more detail using the exemplary embodiments below.

### BRIEF DESCRIPTION OF THE DRAWINGS

Further features of the invention emerge from the following description and from the drawings in which two exemplary embodiments of the invention are illustrated in simplified form.

In said drawings:

FIG. 1 shows a longitudinal section through a first axial rolling bearing according to the invention,

FIG. 2 shows a longitudinal section through a second axial rolling bearing according to the invention,

FIG. 3 shows the dependence of the ram pressure on the rotational speed for different rates of oil flow through a bearing according to FIG. 1, and

FIG. 4 shows the same dependence for a bearing according to FIG. 2.

### DETAILED DESCRIPTION OF THE DRAWINGS

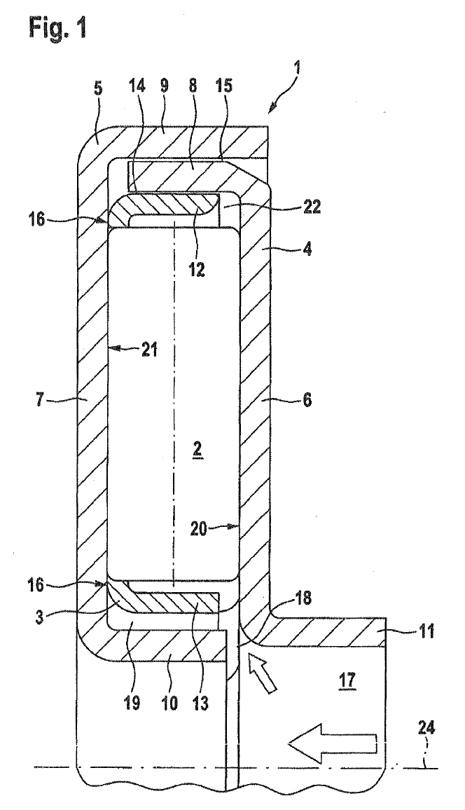

The axial rolling bearing 1 illustrated in FIG. 1 is composed of the rolling body 2 in the form of a cage 3 which contains cylinder rollers and which is arranged between two plane-parallel running disks 4, 5 which are thin walled and are formed from sheet metal. The two running disks 4, 5 have the radial section 6, 7 which forms the raceways 20, 21 for the rolling bodies 2 and which merges with a respective axially directed collar 8, 9 at the radially outer end. As is also apparent, the radially outer running disk 5 is provided, at its inner end, with the axially directed collar 10 which extends in the same direction as the associated collar 9. The radial section 6 of the inner running disk 4 merges, at the inner end, with the flange 11 which extends in the axial direction but in the opposite direction to the associated collar 8. In the present exemplary embodiment, the Z-shaped running disk 4 is to be fixed, i.e. is to be secured in a connection structure, while the running disk 5 rotates with a shaft (not illustrated) about the bearing axle 24.

As is also apparent from FIG. 1, in a neutral position of the axial rolling bearing 1, gaps are formed between the first rim 12 of the cage 3 and the collar 8 as well as between the two collars 8 and 9 of the running disks 4, 5, which gaps are denoted by 14 and 15. A further gap 16 is formed between the radial section 7 of the rotating running disk 5 and the lateral face of the cage 3. Entering lubricant, illustrated by the heavy arrow, first passes the flange 11 of the fixed Z-shaped running disk 4 in the axial direction and into the central receiving bore 17 of the axial running bearing 1, with this flange 11 acting as a baffle. Part of the flow of lubricant can now penetrate radially into the interior of the bearing from the inside, as is illustrated by a further, lighter arrow. The entry point, denoted by 18, is determined by the axial distance between the collar 10 of the running disk 5 and the radial section 6 of the running disk 4. By means of the variable design of this axial distance, the entry of lubricant can be acted on at this point. In other words, the smaller the distance between the collar 10 and the radial section 6, the smaller the flow of lubricant which will penetrate into the bearing 1 and the larger the throttling effect. If the lubricant has penetrated into the lower free space 19 which receives the rolling bodies 2 and the cage 3, there are two possible ways of crossing the bearing 1 in the radial direction. On the one hand, along the raceway 10 arranged on the right, and on the other hand along the raceway 21 arranged on the left, wherein the flowing through sets in along the raceway 20.

The lubricant must firstly move in the radial direction toward the outside along the raceway 20, which is possible without difficulty as a result of the rolling bodies 2 which are spaced apart from another evenly in the circumferential direction. When the lubricant has reached the upper free space 22, there are in turn two possibilities for the further flowing through. On the one hand, this can take place within the pockets (not denoted in more detail), in which case the lubricant has to overcome the sealing gap 16 which is formed by the lateral face of the cage 3 and the raceway 21. After this, the lubricant must still overcome the gap 15 which is formed by the two collars 8 and 9 of the running disks 4 and 5 before it can leave the bearing 1. The other possibility is for the lubricant to emerge from the upper free space 22 through the gap 14 which is formed by the first rim 12 of the cage 3 and by the collar 8 of the running disk 4, before said lubricant can leave the axial rolling bearing 1 via the gap 15.

The lubricant crosses the axial rolling bearing 1 along the raceway 21 as follows:

Starting from the lower free space 19 there are in turn two possibilities. On the one hand, outside the pockets below the second rim 13 of the cage 3, which pockets receive the rolling bodies 2. In this case, it is necessary to overcome the gap 16 which is formed by the raceway 21 and the lateral face of the cage 3. On the other hand, inside the pockets, i.e. the lubricant must exit in the region of the cylindrical lateral face of the rolling bodies 2. The raceway 21 is then in turn overcome between the rolling bodies 2 which are spaced apart from one another in the circumferential direction. At the radial upper end of the rolling body 2 it is in turn necessary to overcome the sealing gap 16 which is formed by the lateral face of the cage 3 and the raceway 21. After this, the lubricant must pass through the gap 15 which, as already described, is formed by the collars 8 and 9, before said lubricant can arrive at the outside. It is obvious that by way of the variable design of the entry point 18, gap 16, gap 14, and gap 15 the throughflow of lubricant through the bearing can be controlled. The narrower the gaps 14, 15, 16, and the entry point 18, the greater the throttling effect of the axial rolling bearing 1.

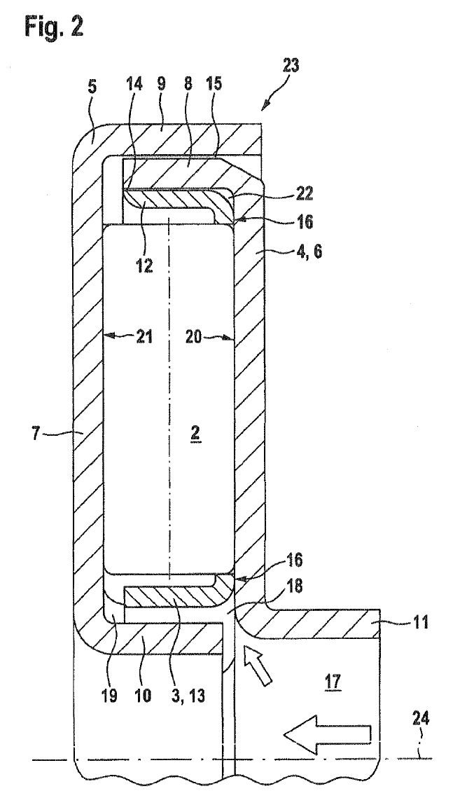

The axial rolling bearing 23, which is illustrated in FIG. 2, differs from that illustrated in FIG. 1 only slightly in that the cage 3 which receives the rolling bodies 2 is guided on the radial section 6 of the fixed Z-shaped running disk 4, i.e. is arranged in mirror-inverted fashion with respect to the cage 3 in FIG. 1. Due to this large degree of correspondence, the same reference signs have been used.

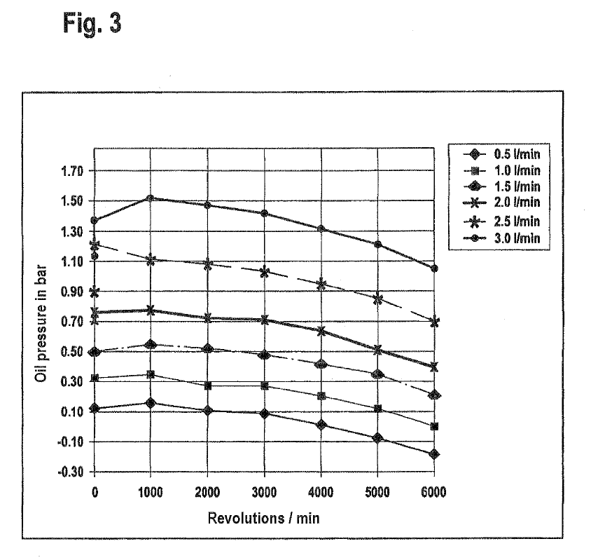

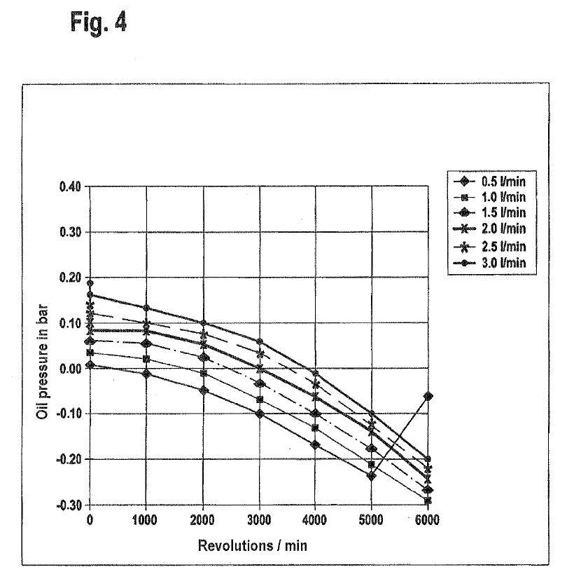

FIGS. 3 and 4 show measuring series in table form, each representing the ram pressure measured in bar in the region of the entry point 18 into the bearing 1, 23 on the vertical axis, and the rotational speed in revolutions per minute on the horizontal axis. The measurements have been carried out at a temperature of 80° C., with different throughflow rates through the bearings 1, 23 being illustrated in the range of 0.5 to 3.0 liters per minute. In both cases, the lower curve represents a throughflow rate of 0.5 l/min, while the upper curve represents a throughflow rate of 3.0 l/min. Between these two there are four further curves which differ from the respective curve below them by a flow rate of 0.5 l/min higher. In FIG. 3, the values are illustrated graphically, which correspond to a lower throughflow rate of lubricant, while in FIG. 4 the values which represent a higher throughflow rate are illustrated. This is apparent from the fact that in the case of FIG. 3 the ram pressure drops to a lesser degree compared to FIG. 4 as the rotational speed of the bearing rises. In other words, a stronger drop in the measured ram pressure corresponds to a higher throughflow rate through the bearing.

### LIST OF REFERENCE NUMBERS

1 Axial rolling bearing
2 Rolling body
3 Cage
4 Running disk
5 Running disk
6 Radial section
7 Radial section
8 Collar
9 Collar
10 Collar
11 Flange
12 First rim
13 Second rim
14 Gap
15 Gap
16 Gap
17 Receiving bore
18 Entry point
19 Lower free space
20 Raceway
21 Raceway
22 Upper free space
23 Axial rolling bearing
24 Bearing axle

1. An axial rolling bearing comprising a cage which contains rolling bodies and is arranged between two running disks, the running disks each have a radial section which forms a raceway, and at their radial outer ends the running disks each have an adjoining axially aligned collar, which are arranged opposite one another in the axial direction and overlap, one of the running disks is a radially outer running disk and the other of the running disks is a radially inner running disk, the radially outer running disk has a larger diameter than the radially inner running disk, wherein the radial extent and the axial extent of the two running disks and their collars and the cage are coordinated with one another in such a way that a labyrinth seal which has a plurality of gaps is formed between them, and the cage is guided on the collar of the radially inner running disk.

2. The axial rolling bearing as claimed in claim 1, wherein the cage is guided in the axial direction on the radial section of the radially outer running disk which is a rotating running disk.

3. The axial rolling bearing as claimed in claim 1, wherein the cage is guided in the axial direction on the radial section of the radially inner running disk which is a fixed running disk.

4. The axial rolling bearing as claimed in claim 1, wherein the cage has a first axially extending rim on its outer radial end.

5. The axial rolling bearing as claimed in claim 1, wherein the radially outer running disk has, on its radially inner end, an axially directed collar which forms a labyrinth seal with a second axially extending rim of the cage.

6. The axial rolling bearing as claimed in claim 1, wherein the radially inner running disk has a flange which is aligned opposite the collar which is arranged on the outer radial end.

7. The axial rolling bearing as claimed in claim 1, wherein the collar of the radially outer running disk has at least one securing nose which points inward in the radial direction and which covers the collar of the radially inner running disk, with the result that a captive unit is formed.

8. The axial rolling bearing as claimed in claim 1, wherein the rolling bearings are embodied as rollers or as needles.
